(19) United States
(12) Patent Application Publication
(10) Pub. No.: US 2012/0312230 A1
(43) Pub. Date: Dec. 13, 2012

(54) APPARATUS FOR FABRICATING RFID LABEL TAG

(75) Inventors: Kwang Hyun Kim, Seoul (KR); Woo Seok Roh, Seoul (KR); Jung Ki Moon, Gwangmyeong-si (KR)

(73) Assignee: LSIS CO., LTD., Anyang-si (KR)

(21) Appl. No.: 13/488,358

(22) Filed: Jun. 4, 2012

(30) Foreign Application Priority Data
Jun. 7, 2011 (KR) 10-2011-0054760

(51) Int. Cl. B05C 5/00; B05C 11/00; B05C 13/02

(52) U.S. Cl. 118/670

(57) ABSTRACT

The present disclosure relates to an apparatus for fabricating an RFID label tag, the apparatus including an air assist pad adhering the RFID label to the label folding unit by discharging air of a predetermined pressure to an RFID label discharged from an RFID label printer, and a retrieving unit retrieving a defective RFID label by moving the defective RFID label to a position of the air assist pad, in a case an RFID label discharged from the RFID label printer is determined to be defective.

Pursuant to 35 U.S.C. §119 (a), this application claims the benefit of earlier filing date and right of priority to Korean Patent Application No. 10-2011-0054760, filed on Jun. 7, 2011, the contents of which are hereby incorporated by reference in their entirety.

### BACKGROUND OF THE DISCLOSURE

1. Field

The present disclosure relates to an apparatus for fabricating an RFID (Radio Frequency Identification) label tag, and more particularly to an RFID label tag attachable to a metallic type product.

2. Background

Generally, an RFID label tag can exhibit the most excellent perceptibility when attached to a non-metal product. However, there are cases where the RFID label tag must be attached to a metal product, if necessary.

The RFID label tag becomes remarkably inferior in perceptibility if directly attached to a metal material, such that there is cumbersomeness in configuring a label that supports an RFID chip with a special material. Price of the label with special material is 10 or more times higher than that of a general type label, and on top of that, the label of special material poses various problems in terms of performance and cost because it needs to develop materials according to attached material.

Recently, an RFID label tag has been developed where it is manufactured with general label material, a certain part of the label is bent, and an RFID tag holding unit attached with an RFID chip is configured to stand erect, whereby the RFID chip can be spaced at a predetermined distance from a surface of a product with a metal material.

FIG. 1 is a schematic view illustrating an apparatus for fabricating an RFID label tag (hereinafter referred to as RFID label tag fabricating apparatus) according to prior art. The RFID label tag fabricating apparatus according to the prior art includes a label print unit (1) printing an RFID label tag, a back sheet supply unit (2) attaching the fabricated RFID label, and a label attaching unit (3) attaching a release tape fed from the back sheet supply unit (2) to the label.

The label having passed the label attaching unit (3) is cut to an adequate size by a label cutter (80), and a back tape perception mark position detecting sensor (90) detects a position of the release tape supplied from the back sheet supply unit (2).

A label bending unit includes a label attachment position horizontal transfer cylinder (10), a label attachment position vertical transfer cylinder (20), a shape formation cylinder (30), a shape formation fixing bracket (40), a shape formation transfer bracket (50) and an air assist pad (60).

Meantime, in the RFID label tag fabricating apparatus thus configured is devoid of a module for defect disposal, such that even if there occurs defects during RFID label fabrication, the defects are inputted into a storage box after forming and cutting processes, and the defects are visually selected by an operator and the tag is attached by a manual operation for each tag.

Thus, there may be a case where defective labels are attached to a product due to erroneous operation of the operator.

It is, therefore, desirable and indispensible to overcome the above problems and others by adding a process of determining defects by selecting labels issued by the attaching operator.

Particularly, air discharged by the air assist pad (60) is impossible to be controlled at each moving step, thereby resulting in a problem of difficulty in forming a shape of a highly accurate smart label.

The above information disclosed in this Background section is only for enhancement of understanding of the background of the disclosure and therefore it may contain information that does not form the prior art that is already known in this country to a person of ordinary skill in the art.

### SUMMARY

The present disclosure is disclosed to obviate the above-mentioned disadvantages, and it is an object of the present disclosure to provide an apparatus for fabricating an RFID (Radio Frequency Identification) label tag configured to be formed with an air assist pad improved in structure for ejecting airs of each different pressure for each fabricating step of process.

In one general aspect of the present disclosure, there is provided an apparatus for fabricating an RFID (Radio frequency identification) label tag, the apparatus comprising: an RFID label printer continuously discharging RFID labels; a label folding unit folding the RFID labels discharged from the RFID label printer in a protruding shape; an air assist pad adhering the RFID label to the label folding unit by discharging air of a predetermined pressure to the RFID label discharged from the RFID label printer, and a retrieving unit retrieving a defective RFID label by moving the defective RFID label to a position of the air assist pad in a case an RFID label discharged from the RFID label printer is determined to be a defective, wherein the air assist pad includes a plurality of air ejection nozzles each having a different diameter and an ejection direction.

In some exemplary embodiments, the apparatus further comprises an alarm unit generating an alarm, in a case the defective labels are stacked to a predetermined height of the retrieving unit.

In some exemplary embodiments, the alarm unit visually or audibly generates an alarm.

In some exemplary embodiments, an air ejection nozzle, formed at both distal ends of the air assist pad among the plurality of air ejection nozzles, ejects air to a direction perpendicular to the printed RFID label.

In some exemplary embodiments, an air ejection nozzle, formed at a section facing a section where the RFID label is folded in the air assist pad among the plurality of air ejection nozzles, ejects air to a direction slanted to a predetermined angle from a direction perpendicular to the printed RFID label.

In some exemplary embodiments, an air ejection nozzle among the plurality of air ejection nozzles ejects air to a direction slanted at a predetermined angle relative to the printed RFID label along a moving direction of the label folding unit towards a center.

In some exemplary embodiments, the air assist pad and the retrieving unit are selectively operated.

The apparatus for fabricating an RFID label tag according to the present disclosure has an advantageous effect in that an air ejection nozzle of an air assist pad is so shaped as to eject airs, each air having a different pressure for each fabricating step of process, to enable formation of a shape catering to a high accuracy of smart label.

Another advantage is that defective RFID labels and normal RFID labels are discharged without being mixed to dispense with input of separate efforts and time for discerning defects and to enhance work efficiency.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description, serve to explain the principle of the disclosure. In the drawings:

FIG. 1 is a schematic view illustrating an apparatus for fabricating RFID label tag according to prior art;

FIG. 2 is a schematic view illustrating an apparatus for fabricating RFID label tag according to an exemplary embodiment of the present disclosure; and

FIGS. 3A to 3G are schematic views illustrating an air assist pad having a plurality of air nozzles each nozzle having a different diameter, as an essential part of FIG. 2.

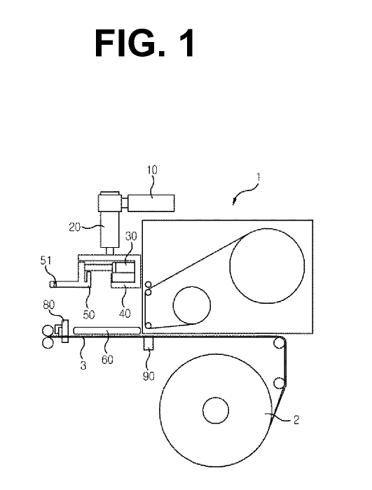

### DETAILED DESCRIPTION

Hereinafter, exemplary embodiments of the present disclosure are described in detail with reference to the accompanying drawings. Detailed descriptions of well-known functions, configurations or constructions are omitted for brevity and clarity so as not to obscure the description of the present disclosure with unnecessary detail. Furthermore, the same reference numerals will be assigned to the same elements in the explanation of the figures.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted. Now, the present invention will be described in detail with reference to the accompanying drawings.

Words such as “thereafter,” “then,” “next,” “therefore”, etc. are not intended to limit the order of the processes; these words are simply used to guide the reader through the description of the methods.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

Now, the apparatus for fabricating an RFID label tag according to exemplary embodiments of the present disclosure will be described in detail with reference to the accompanying drawings.

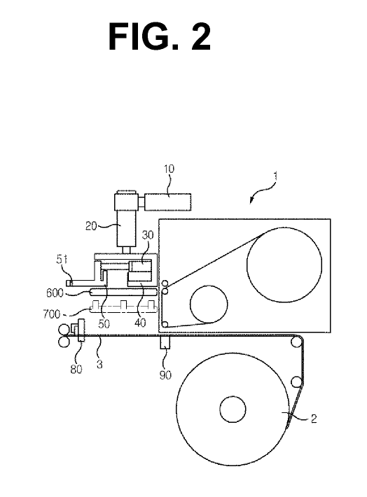

FIG. 2 is a schematic view illustrating an apparatus for fabricating RFID label tag according to an exemplary embodiment of the present disclosure.

An overall configuration of the apparatus for fabricating RFID label tag according to the present disclosure is similar to that of the prior art.

That is, the apparatus includes a label print unit (1) printing an RFID label tag, a back sheet supply unit (2) attaching the fabricated RFID label, and a label attaching unit (3) attaching a release tape fed from the back sheet supply unit (2) to the label.

The label having passed the label attaching unit (3) is cut to an adequate size by a label cutter (80), and a back tape perception mark position detecting sensor (90) detects a position of the release tape supplied from the back sheet supply unit (2).

Meanwhile, a label folding unit for folding the RFID labels discharged from the RFID label printer in a desired shape includes a label attachment position horizontal transfer cylinder (10), a label attachment position vertical transfer cylinder (20), a shape formation cylinder (30), a shape formation fixing bracket (40), a shape formation transfer bracket (50), an air assist pad (600) having a configuration different from that of the prior art, and a retrieving unit (700) marking/removing defectively printed RFID label tags.

The label attachment position horizontal transfer cylinder (10) determines a horizontal attachment position of the label, the label attachment position vertical transfer cylinder (20) determines a vertical attachment position of the label, and the shape formation fixing bracket (40) and the shape formation transfer bracket (50) may fold the labels transferred through movement/pressure operations of the shape formation cylinder (30) to a predetermined height. Reference numeral 51 is a label shape formation transfer detecting sensor to detect positions of the shape formation fixing and transfer brackets (40, 50) moved by the shape formation cylinder (30).

The characteristic of the present disclosure lies in the configuration of the air assist pad (600), classification of defectively printed RFID labels and configuration of retrieving unit (700) marking and removing the defectively printed RFID label tags.

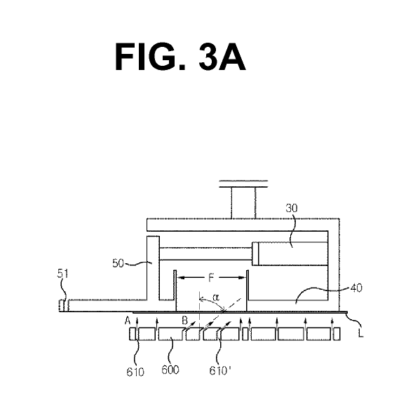

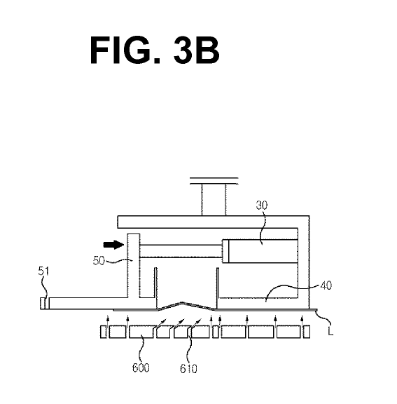

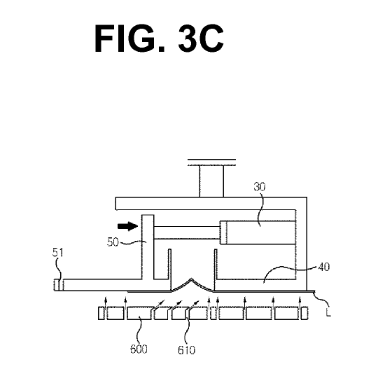

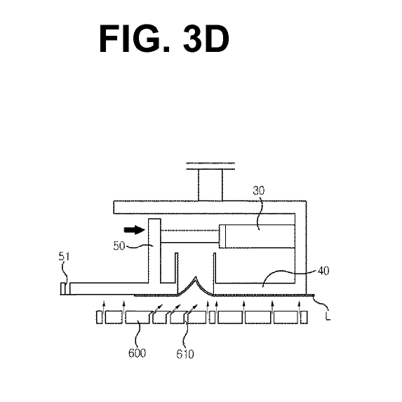

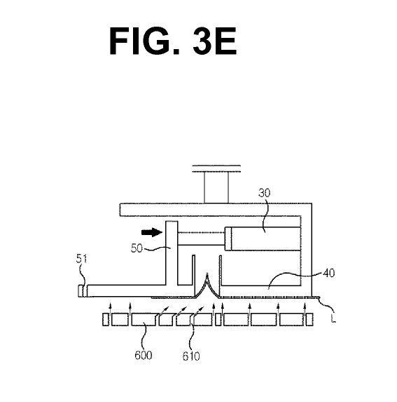

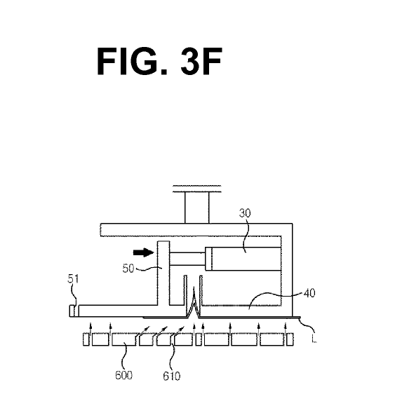

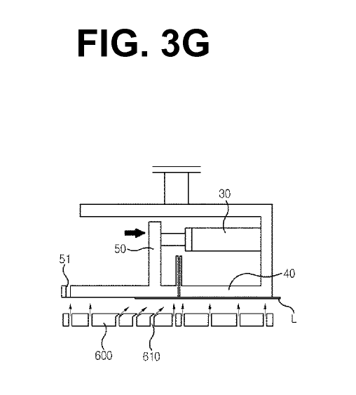

Referring to FIG. 3A, the air assist pad (600) according to an exemplary embodiment of the present disclosure includes a plurality of air ejection nozzles (610), and when air of a predetermined pressure is discharged by air discharged by the air ejection nozzles (610), the labels are easily folded by pressing operation of the shape formation fixing and transfer brackets (40, 50).

That is, a plurality of air ejection nozzles (610) is formed through the air assist pad (600), and particularly, the air ejection nozzles (610) penetratively formed at both distal ends of the air assist pad (600) eject air to an arrow direction (A) perpendicular to an RFID label (L) to adhere the RFID label (L) to the shape formation fixing and transfer brackets (40, 50).

At this time, each of the shape formation fixing and transfer brackets (40, 50) are maximally discrete, and an air ejection nozzle (610′) penetratively formed at the air assist pad (600) facing an ‘F’ section, which is a section where an actually printed RFID label (L) is folded, is changed in air ejection direction to a direction slanted as much as a predetermined angle (α) as illustrated in FIG. 3a, and ejects air to an arrow direction (B).

The arrow direction (B) is a direction where the RFID label (L) is folded in response to movement of the shape formation transfer bracket (50) to the shape formation fixing bracket (40).

According to the configuration thus described, as illustrated in FIGS. 3B to 3G, the direction of air ejected from the air assist pad (600) is changed in response to the folding process of the RFID label (L), whereby a folding process can be progressed under a state where the RFID label (L) outputted from the label print unit (1) is fixed.

Meanwhile, although not illustrated, the shape formation fixing and transfer brackets (40, 50) may further include vacuum suction means to allow the RFID label (L) to be more strongly adhered to the shape formation fixing and transfer brackets (40, 50) in the folding process.

The air assist pad (600) is operated only when the RFID label (L) is normally discharged from the label print unit (1), and if it is determined by a predetermined detecting means that the printed RFID label (L) is not normal, the discharged RFID label (L) needs no folding process. If the folding process is performed to fabricate the RFID label (L) despite the abovementioned error, it is difficult for an operator to determine the erred RFID label tag until an operator visually check the erred RFID label tag.

The present disclosure, in an effort to improve the disadvantages or problems of the prior art, deletes the folding process if it is determined by the detecting means that the printed RFID label (L) is defective, the air assist pad (600) keeps being positioned at a rear side of the apparatus, which is an original position thereof, and the retrieving unit (700) is arranged thereat and waits.

Then, the label attachment position vertical transfer cylinder (20) moves downward to cause the defective RFID label to be attached to the retrieving unit (700), where the retrieving unit (700) attached with the defective RFID label is returned to a rear surface of the apparatus. The defective RFID labels attached to the retrieving unit (700) are sequentially accumulated on an upper side, and if the defective RFID labels are stacked to a pre-set height, the operator can manually remove the defective RFID labels by an alarm of an alarm unit (not shown) that notifies the arrival of the defective RFID labels. The alarm unit may visually or audibly provide the alarm to the operator.

Now, a method for fabricating an RFID label tag based on the above-mentioned apparatus will be described.

In a case an electric power is applied to the apparatus, the air assist pad (600) and the retrieving unit (700) move to a rear side of the apparatus to wait for a command. If a printing of the RFID labels (L) is continuously started by the RFID label printer (1), the air assist pad (600) moves downwards of the label folding unit to eject air to a bottom surface of the outputted RFID label (L) and to prevent issuing RFID labels (L) from dropping. At this time, if necessary, the apparatus may further include a vacuum suction unit to further prevent the RFID labels from dropping.

Furthermore, a predetermined detecting unit determines whether the printed RFID labels (L) are normal. As a result of the determination, if it is determined that the issued RFID labels (L) are normal, air ejected from the air assist pad (600) is so controlled as to be changed in ejection directions and angles in response to the folding process of the label folding unit, a label folding process is performed and a smart label is completed in shape thereof.

The RFID label (L) is determined of completion of folding process by the label shape formation transfer detecting sensor (51), and if it is determined that the folding process is completed, the air assist pad (600) moves to a rear surface of the apparatus, which is an original position, and the completed RFID labels are attached to a release tape and discharged.

If it is determined that the issued RFID label are defective, the label folding unit is stopped in operation, the retrieving unit (700), instead of the air assist pad (600), is moved to the position and the defective RFID labels are attached to the retrieving unit (700), being unfolded, by the vertical label attachment position vertical transfer cylinder (20). The attached defective RFID labels are sequentially attached and stacked to a predetermined height at an upper side of the retrieving unit (700), and if the attached defective RFID labels are stacked to the predetermined height or higher, an alarm is generated to allow the operator to remove the defective RFID labels.

As apparent from the foregoing, the apparatus for fabricating the RFID label tags according to the present disclosure thus described has an industrial applicability in that label folding process can be more effectively carried out, and defective RFID labels and normal RFID labels are discharged without being mixed to dispense with input of separate efforts and time for discerning defects and to enhance work efficiency.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the present invention as defined by the following claims.

What is claimed is:

1. An apparatus for fabricating an RFID (Radio frequency identification) label tag, the apparatus comprising: an RFID label printer continuously discharging RFID labels; a label folding unit folding the RFID labels discharged from the RFID label printer in a protruding shape; an air assist pad adhering the RFID label to the label folding unit by discharging air of a predetermined pressure to the RFID label discharged from the RFID label printer, and a retrieving unit retrieving a defective RFID label by moving the defective RFID label to a position of the air assist pad, in a case an RFID label discharged from the RFID label printer is determined to be defective, wherein the air assist pad includes a plurality of air ejection nozzles each having a different diameter and an ejection direction.

2. The apparatus of claim 1, further comprising an alarm unit generating an alarm, in a case the defective labels are stacked to a predetermined height of the retrieving unit.

3. The apparatus of claim 2, wherein the alarm unit visually or audibly generates an alarm.

4. The apparatus of claim 1, wherein an air ejection nozzle, formed at both distal ends of the air assist pad among the plurality of air ejection nozzles, ejects air to a direction perpendicular to the printed RFID label.

5. The apparatus of claim 1, wherein an air ejection nozzle, formed at a section facing a section where the RFID label is folded in the air assist pad among the plurality of air ejection nozzles, ejects air to a direction slanted to a predetermined angle from a direction perpendicular to the printed RFID label.

6. The apparatus of claim 1, wherein an air ejection nozzle among the plurality of air ejection nozzles ejects air to a direction slanted at a predetermined angle relative to the printed RFID label along a moving direction of the label folding unit towards a center.

7. The apparatus of claim 1, wherein the air assist pad and the retrieving unit are selectively operated.
